(19) United States
(12) Patent Application Publication
(10) Pub. No.: US 2026/0326575 A1
(43) Pub. Date: Oct. 22, 2026

(54) VEHICLE INCLUDING AN ACCELERATOR PEDAL POSITION SENSOR AND A METHOD FOR CONTROLLING THE SAME

(71) Applicants: HYUNDAI MOTOR COMPANY, Seoul (KR); KIA CORPORATION, Seoul (KR)

(72) Inventors: Do Hwa Kim, Hwaseong-si (KR); Seong Deok Seo, Hwaseong-si (KR); Jung Hwan Bang, Hwaseong-si (KR); Sung Bae Jeon, Hwaseong-si (KR)

(73) Assignees: HYUNDAI MOTOR COMPANY, Seoul (KR); KIA CORPORATION, Seoul (KR)

(21) Appl. No.: 19/294,624

(22) Filed: Aug. 8, 2025

(30) Foreign Application Priority Data
Apr. 16, 2025 (KR) 10-2025-0049710

(51) Int. Cl. B60L 15/10

(52) U.S. Cl. CPC B60L 15/10; B60L 2240/12; B60L 2240/42; B60L 2240/54; B60L 2240/642; B60L 2250/26; B60L 2260/20

(57) ABSTRACT

A vehicle includes a drive motor, a battery, an accelerator pedal position sensor, and a controller configured to determine an output signal change amount of the accelerator pedal position sensor for a plurality of SoC (State of Charge) ranges of the battery during a time taken for each SoC of the battery to decrease by a preset amount due to discharge for operating the drive motor during vehicle driving, determine a change rate corresponding to a current power saving mode within a range of an output signal change rate per unit time determined based on the output signal change amount for the plurality of SoC ranges, and limit an output signal change rate of the accelerator pedal position sensor within the determined change rate to operate the drive motor.

### CROSS-REFERENCE TO THE RELATED APPLICATION

The present application claims priority to Korean Patent Application No. 10-2025-0049710, filed on Apr. 16, 2025, in the Korean Intellectual Property Office, the entire contents of which are incorporated herein for all purposes by this reference.

### BACKGROUND OF THE PRESENT DISCLOSURE

### 1. Field of the Present Disclosure

The present disclosure relates to a vehicle including an accelerator pedal position sensor and a method for controlling the same in order to conserve driving energy.

### 2. Description of the Related Art

A variety of techniques are being developed to reduce vehicle power consumption. For example, Eco Drive Mode is a technique for reducing unnecessary power consumption by limiting a torque output of an engine or a motor, or by efficiently controlling a load device such as an air conditioning system.

In addition, in electrified vehicles, a regenerative braking system has been proposed as a technique for reducing driving energy. Such a regenerative braking system is a technique for converting vehicle's kinetic energy into electrical energy during braking, storing the converted energy in a battery, and then re-using the energy to drive an electric motor in vehicle traveling, thereby improving vehicle fuel economy.

As described above, various techniques are being developed to reduce driving energy, but these techniques have limitations in terms of insufficient consideration of driving characteristics of individual drivers. For example, the frequency and intensity of rapid acceleration or rapid deceleration may vary depending on drivers even when driving on the same road. These driving habits directly affect energy consumption. Accordingly, it is desirable to provide a control method capable of conserving energy efficiently in consideration of the driving tendencies of each driver.

The above information disclosed in this Background section is provided only to enhance understanding of the background of the disclosure. Therefore, the Background section may contain information that does not form the prior art that is already known to those of ordinary skill in the art.

### SUMMARY

Various aspects of the present disclosure are directed to providing a vehicle including an accelerator pedal position sensor and a method for controlling the same in order to conserve driving energy.

The technical objects of the embodiments of the present disclosure are not limited to the technical objects mentioned above, and other technical objects not mentioned should be clearly understood by those of ordinary skill in the art to which the present disclosure pertains from the following description.

In accordance with an aspect of the present disclosure, the above and other objects can be accomplished by the provision of a vehicle including a drive motor, a battery, an accelerator pedal position sensor, and a controller. The controller may determine an output signal change amount of the accelerator pedal position sensor for a plurality of SoC (State of Charge) ranges of the battery during a period of time taken for a SoC of the battery to decrease by a preset amount due to discharge for operating the drive motor during vehicle driving. Additionally, the controller may determine a change rate corresponding to a current power saving mode within a range of an output signal change rate per unit time determined based on the output signal change amount for the plurality of SOC ranges, and limit an output signal change rate of the accelerator pedal position sensor within the determined change rate to operate the drive motor.

The output signal change amount of the accelerator pedal position sensor for the plurality of SoC ranges may be absolute values of a difference between signal values output by the accelerator pedal position sensor at a starting point and an ending point of each of the SoC ranges of the battery or absolute values of a difference between an upper limit value and a lower limit value of the signal values output by the accelerator pedal position sensor in each of the SoC ranges of the battery.

The power saving mode may include a plurality of stages, and the controller may determine different change rates within the range of the output signal change rate per unit time for each of the plurality of stages.

The controller may determine a change rate at a current power saving mode stage among the plurality of stages according to the following equation:

$$Δ APS = Δ AP {S}_{M A X} - ( \frac{Δ AP {S}_{M A X} - Δ AP {S}_{MIN}}{N} ) \times m$$

where ΔAPS represents the change rate at the current power saving mode stage, ΔAPS_{MAX} represents an upper limit value of change rate in the range of the output signal change rate per unit time, ΔAPS_{MIN} represents a lower limit value of change rate in the range of the output signal change rate per unit time, N represents the number of power saving mode stages, and m represents a numerical value corresponding to the current power saving mode stage.

The controller may determine the power saving mode stage based on a preset standard, or may determine the power saving mode stage based on an input to enter the power saving mode received from a driver.

The controller may operate the drive motor by limiting the output signal change rate of the accelerator pedal position sensor within the determined change rate, in a case where a speed of the vehicle is equal to or higher than a preset reference value and a slope of a road on which the vehicle is traveling is less than or equal to a reference slope.

The controller may operate the drive motor based on an output signal of the accelerator pedal position sensor, regardless of the current power saving mode, in a case where a speed of the vehicle is lower than a preset reference value or a slope of a road on which the vehicle is traveling is greater than a reference slope.

In accordance with another aspect of the present disclosure, there is provided a method for controlling an accelerator pedal position sensor, including: determining, by a controller, an output signal change amount of the accelerator pedal position sensor for a plurality of SoC (State of Charge) ranges of a battery during a period of time taken for a SoC of the battery to decrease by a preset amount due to discharge for operating a drive motor during vehicle driving, determining, by the controller, a change rate corresponding to a current power saving mode within a range of an output signal change rate per unit time determined based on the output signal change amount for the plurality of SoC ranges; and limiting, by the controller, an output signal change rate of the accelerator pedal position sensor within the determined change rate to operate the drive motor.

The output signal change amount of the accelerator pedal position sensor for each of the plurality of SoC ranges may be absolute values of a difference between signal values output by the accelerator pedal position sensor at a starting point and an ending point of each of the SoC ranges of the battery or absolute values of a difference between a upper limit value and a lower limit value of the signal values output by the accelerator pedal position sensor in each of the SoC ranges of the battery.

The power saving mode may include a plurality of stages, and the determining different change rates may include determining different change rates within the range of the output signal change rate per unit time for each of the plurality of stages, by the controller.

The determining a change rate may include determining a change rate at a current power saving mode stage among the plurality of stages according to the following equation, by the controller:

$$Δ APS = Δ AP {S}_{M A X} - ( \frac{Δ AP {S}_{M A X} - Δ AP {S}_{MIN}}{N} ) \times m$$

where ΔAPS represents the change rate at the current power saving mode stage, ΔAPS_{MAX} represents an upper limit value of change rate in the range of the output signal change rate per unit time, ΔAPS_{MIN} represents a lower limit value of change rate in the range of the output signal change rate per unit time, N represents the number of power saving mode stages, and m represents a numerical value corresponding to the current power saving mode stage.

The controller may determine the power saving mode stage based on a preset standard, or may determine the power saving mode stage based on an input to enter the power saving mode received from a driver.

The operating the drive motor may include operating the drive motor by limiting the output signal change rate of the accelerator pedal position sensor within the determined change rate, in a case where a speed of the vehicle is equal to or higher than a preset reference value and a slope of a road on which the vehicle is traveling is less than or equal to a reference slope, by the controller.

The operating the drive motor may include operating the drive motor based on an output signal of the accelerator pedal position sensor, regardless of the current power saving mode, in a case where a speed of the vehicle is lower than a preset reference value or a slope of a road on which the vehicle is traveling is greater than a reference slope, by the controller.

In accordance with another aspect of the present disclosure, there is provided a vehicle including a drive motor; a battery; an accelerator pedal position sensor; and a controller. The controller may be configured to: determine an output signal change amount of the accelerator pedal position sensor for a plurality of SoC (State of Charge) ranges of the battery during a period of time taken for a SoC of the battery to decrease by a preset amount; determine a change rate corresponding to a current power saving mode within a range of an output signal change rate per unit time determined based on the output signal change amount for the plurality of SoC ranges; and limit an output signal change rate of the accelerator pedal position sensor within the determined change rate.

The output signal change amounts of the accelerator pedal position sensor for the plurality of SoC ranges may be absolute values of a difference between signal values output by the accelerator pedal position sensor at a starting point and an ending point of each of the SoC ranges of the battery or are absolute values of a difference between an upper limit value and a lower limit value of the signal values output by the accelerator pedal position sensor in each of the SoC ranges of the battery.

The power saving mode may include a plurality of stages, and the controller is further configured to determine different change rates within the range of the output signal change rate per unit time for each of the plurality of stages.

The controller is further configured to determine the power saving mode stage based on a preset standard.

The controller is configured to determine the power saving mode stage based on an input to enter the power saving mode received from a driver.

The controller may be further configured to operate the drive motor based on an output signal of the accelerator pedal position sensor, regardless of the current power saving mode, in a case where a speed of the vehicle is lower than a preset reference value or a slope of a road on which the vehicle is traveling is greater than a reference slope.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a block diagram showing an example of a vehicle configuration according to an embodiment of the present disclosure;

FIG. 2 is a flowchart for determining a signal change rate of an accelerator pedal position sensor to be limited according to an embodiment of the present disclosure;

FIG. 3 is a flowchart for controlling a signal change rate of an accelerator pedal position sensor in a case where a vehicle enters a power saving mode according to an embodiment of the present disclosure;

FIG. 4 is a time graph showing a signal value of an accelerator pedal position sensor and an SoC of a battery corresponding thereto according to an embodiment of the present disclosure;

FIGS. 5 and 6 are graphs illustrating a method for determining a signal change amount of an accelerator pedal position sensor according to an embodiment of the present disclosure; and

FIG. 7 is a diagram showing a vehicle that is traveling on a road with different slope gradients according to an embodiment of the present disclosure.

### DETAILED DESCRIPTION

The following specific structural or functional descriptions of embodiments of the present disclosure are merely describing the exemplified for the purpose of embodiments according to the present disclosure. The embodiments according to the present disclosure may be implemented in various other forms.

Reference is made in detail to various embodiments of the present disclosure, examples of which are illustrated in the accompanying drawings and described below. The present description is not intended to limit the disclosure to the embodiments described herein, and various alternatives, modifications, equivalents and other embodiments should be interpreted as being within the spirit and scope of the disclosure.

Unless clearly defined otherwise, terms used herein, including technical or scientific terms have the same meaning as understood by those having ordinary skill in the art. Terms defined in commonly used dictionaries should be interpreted as having meanings consistent with meanings in the context of the related technology, and unless clearly defined in this specification, should not be interpreted as having ideal or excessively formal meanings.

Hereinafter, reference is made in detail to various embodiments of the present disclosure, examples of which are illustrated in the accompanying drawings. Wherever possible, the same reference numbers have been used throughout the drawings to refer to the same or like parts.

In the description of the following embodiments, the term “preset” means that, in a case where a parameter is used in a process or algorithm, a value of the parameter is set or determined in advance. Depending on the embodiments, the value of the parameter may be set when the process or algorithm starts, or may be set during a section in which the process or algorithm is performed.

The suffixes “module” and “unit” for components used in the following description are given or used interchangeably only for ease of description of the specification, and do not have distinct meanings or roles in themselves.

In describing the embodiments, detailed descriptions of related known technologies have been omitted as necessary. It should be understood that the accompanying drawings are given hereinafter by way of illustration only and do not limit the disclosure, and the present disclosure is intended to cover various alternatives, modifications, equivalents and other embodiments, within the spirit and scope of the disclosure as defined by the appended claims.

It should be understood that, although the terms “first”, “second”, etc. may be used herein to describe various elements, these elements should not be limited by these terms. These terms are only used to distinguish one element from another.

Further, it should be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween.

As used herein, the singular forms “a” and “an” are intended to include the plural forms as well, unless the context clearly indicates otherwise.

It should be further understood that the terms “comprise”, “include”, and “have” used herein merely specify the presence of stated features, numbers, steps, operations, components, parts, or combinations thereof, but do not preclude the presence or addition of one or more other features, numbers, steps, operations, components, parts, or combinations thereof.

In addition, a “unit” or a “control unit” included in names of a motor control unit (MCU), a hybrid control unit (HCU), and the like merely refers to a controller that controls specific vehicle functions, and does not refer to a generic functional unit.

For example, each control unit may include a communication device that communicates with other control units or sensors, a memory that stores an operating system or logic instructions and input/output information, and one or more processors that perform necessary determinations, operations, and the like. When a component, unit, controller, device, element, or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

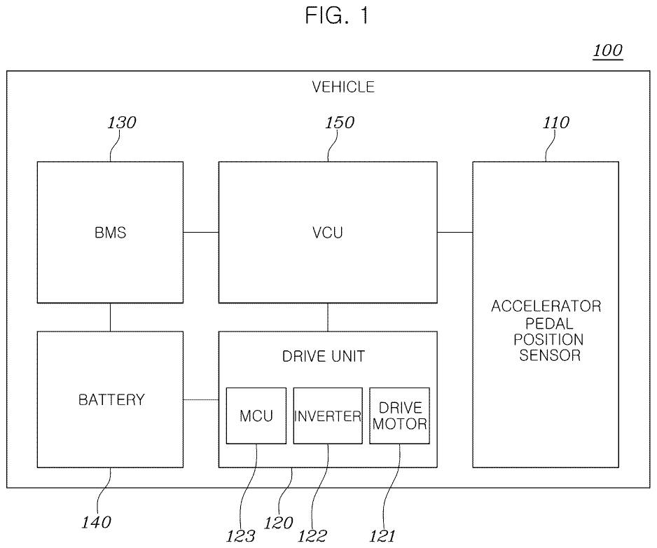

FIG. 1 is a block diagram showing an example of a configuration of a vehicle 100 applicable to an embodiment of the present disclosure.

Referring to FIG. 1, the vehicle 100 may include an accelerator pedal position sensor 110, a drive unit 120, a battery management system (BMS) 130, a battery 140, and a vehicle control unit (VCU) 150. Hereinafter, the respective components are described in more detail. Throughout the following description, the term ‘controller’ has been used to refer to the vehicle control unit (VCU) 150.

First, the accelerator pedal position sensor 110 may detect a driver's accelerator pedal operation, may generate an electrical signal corresponding to the detected operation, and may transmit the electrical signal to the controller 150. The transmitted electrical signal may be used to drive a drive motor 121 of the drive unit 120 by the controller 150, which is described in detail in connection with the controller 150.

In the present embodiment, the drive unit 120 may include the drive motor 121, an inverter 122, and a drive motor control unit (MCU) 123, for example. First, the drive unit 120 may generate a driving force for vehicle driving, and may transmit the generated driving force to wheels of the vehicle 100. Specifically, the drive motor control unit 123 may receive information on the accelerator pedal operation detected by the accelerator pedal position sensor 110 from the controller 150, and may determine a torque necessary for the drive motor 121 based on the received accelerator pedal operation. The drive motor control unit 123 may determine electrical energy necessary to provide the determined torque, and may provide a control signal to the inverter 122 based on the determined electrical energy. The inverter 122 may receive Direct Current (DC) power supplied from the battery 140, and may convert the DC power into Alternating Current (AC) power based on the control signal provided by the drive motor control unit 123. The drive motor 121 may form a magnetic field using the AC power converted by the inverter 122, and may generate a torque through the formed magnetic field to drive the wheels of the vehicle 100.

The battery management system 130 may monitor states of voltage, current, temperature, and the like of the battery 140 in real time for efficient operation of the battery 140. In the present embodiment, the battery management system 130 may provide information on SoC (State of Charge) of the battery 140 to the controller 150. The controller 150 may determine a signal change rate of the accelerator pedal position sensor 110 for each SoC range of the battery 140, based on the information on the SoC of the battery 140 provided from the battery management system 130 and a signal of the accelerator pedal position sensor 110 transmitted from the accelerator pedal position sensor 110, which is described in more detail below in connection with the controller 150.

The controller 150 may function as a higher-level control unit for performing overall control of a power electric (PE) system including driving of an electrified vehicle. In the present embodiment, the controller 150 may operate the drive motor 121 of the drive unit 110 based on the signal received from the accelerator pedal position sensor 110.

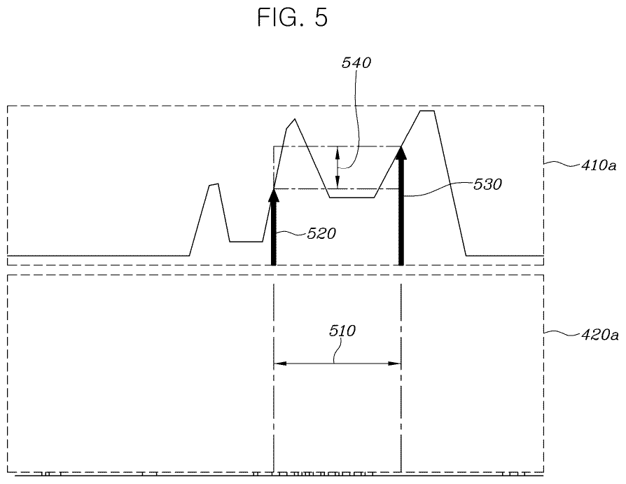

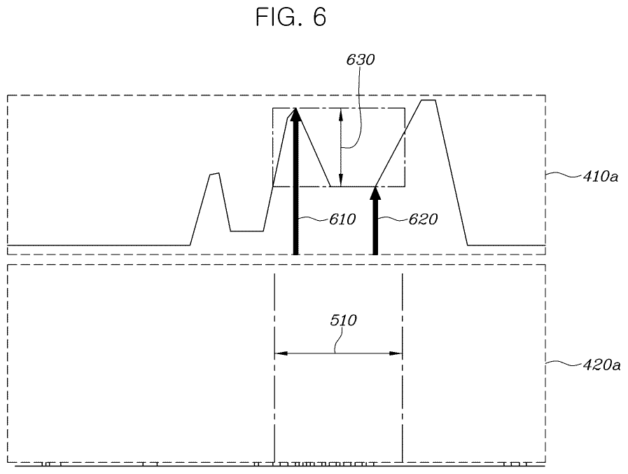

In the present embodiment, the controller 150 may determine an output signal change amount of the accelerator pedal position sensor 110 for a plurality of SoC ranges of the battery 140 during a time taken for the SoC of the battery 140 to decrease by a preset amount due to discharge for operating the drive motor 121 during driving. According to some examples, each of the plurality of SoC ranges of the battery may correspond to the time taken for the SoC of the battery to decrease by the preset amount. Here, there are various methods for determining the output signal change amount of the accelerator pedal position sensor 110 for the time taken as described above by the controller 150, but in the present embodiment, two methods are proposed. First, the controller 150 may determine an absolute value of a difference between signal values output by the accelerator pedal position sensor 110 at a starting point and an ending point of each of the SoC ranges of the battery 140 as the output signal change amount of the accelerator pedal position sensor 110. Second, the controller 150 may determine a difference between an upper limit value and a lower limit value of the signal values output by the accelerator pedal position sensor 110 in each of the SoC ranges of the battery 140 as the output signal change amount of the accelerator pedal position sensor 110. Referring to FIGS. 5 and 6, a method for determining the output signal change amount of the accelerator pedal position sensor 110 is described in more detail. The above-mentioned method for determining the output signal change amount of the accelerator pedal position sensor 110 is provided by way of example only, and the present disclosure is not necessarily limited thereto.

The controller 150 may determine an output signal change rate per unit time based on the time taken for each Soc range of the battery 140 and the output signal change amount of the accelerator pedal position sensor 110 as determined above. The controller 150 may determine a change rate corresponding to a power saving mode within a range of the output signal change rate per unit time for each SoC range of the determined battery 140.

In the vehicle 100, the power saving mode allows the controller 150 to stop an operation of high-power sensors, etc., or to cause the sensors, etc. to enter a low-power state in order to minimize power consumption of the battery 140. In the present embodiment, in a case where the vehicle 100 enters the power saving mode, the controller 150 may limit the signal change rate of the accelerator pedal position sensor 110 to reduce power consumed by the drive motor 121.

In the present embodiment, the power saving mode may be a criterion for determining the signal change rate of the accelerator pedal position sensor 110 to be limited by the controller 150. Specifically, the power saving mode may be divided into a plurality of stages. The controller 150 may determine different change rates within the range of the output signal change rate per unit time for each of the plural Soc ranges of the battery 140 for each of the plural stages of the power saving mode. For each stage, the method for determining different output signal change rates of the accelerator pedal position sensor 110 may vary, but in the present embodiment, the controller 150 may determine a change rate corresponding to a current power saving mode stage among the plural stages according to the following Equation 1.

$$Δ APS = Δ AP {S}_{M A X} - ( \frac{Δ AP {S}_{M A X} - Δ AP {S}_{MIN}}{N} ) \times m \qquad [ Equation 1 ]$$

Here, ΔAPS represents a change rate at a stage corresponding to a current power saving mode, ΔAPS_{MAX} represents a upper limit value of change rate in a range of an output signal change rate per unit time determined for each of the SoC ranges of the battery 140, ΔAPS_{MIN} represents a lower limit value of change rate in the range of the output signal change rate per unit time determined for each of the Soc ranges of the battery 140, N represents the number of power saving mode stages, and m represents a numerical value corresponding to the current power saving mode stage. The method for determining the output signal change rate of the accelerator pedal position sensor 110 corresponding to the current power saving mode stage is provided by way of example only, and the present disclosure is not limited thereto.

The controller 150 may determine the stage of the power saving mode based on a preset standard or based on a mode entry command received from a driver, for example. However, the present disclosure is not limited thereto, and the controller 150 may determine the stage of the power saving mode on another basis.

In a case where the preset conditions are satisfied, the controller 150 may operate the drive motor 121 of the drive unit 120 by limiting the change rate of the output signal of the accelerator pedal position sensor 110 based on the output signal change rate for each power saving mode determined as described above. In the present embodiment, in a case where a speed of the vehicle 100 is equal to or higher than a preset reference value and a slope of a road on which the vehicle 100 is traveling is less than or equal to a reference slope, the controller 150 may operate the drive motor 121 by limiting the change rate of the output signal of the accelerator pedal position sensor 110 within the determined output signal change rate. In a case where the speed of the vehicle 100 is lower than the preset reference value or the slope of the road on which the vehicle 100 is traveling is greater than the reference slope, the controller 150 may operate the drive motor 121 based on the output signal of the accelerator pedal position sensor 110, regardless of the current power saving mode. The reason for the above-mentioned conditions is as follows. For example, in a case where the vehicle 100 that is traveling at a speed lower than a preset reference speed enters a highway, the vehicle 100 may inevitably have to accelerate rapidly to match a vehicle that is traveling in a main lane. In such a situation, the controller 150 may have to operate the drive motor 121 without limiting the change rate of the output signal of the accelerator pedal position sensor 110. In addition, in a case where the vehicle 100 is traveling on a road with a slope greater than the preset reference slope, it is necessary to secure high torque to prevent the vehicle 100 from rolling backward, and thus, the controller 150 may have to operate the drive motor 121 based on the output signal of the accelerator pedal position sensor 110 without limiting the output signal change rate of the accelerator pedal position sensor 110. The above-mentioned conditions are provided merely as examples and the present disclosure is not necessarily limited thereto.

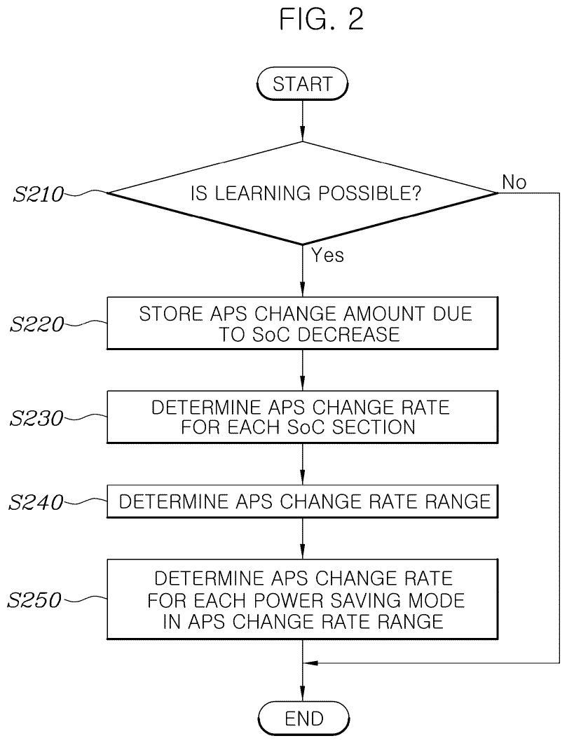

FIG. 2 is a flowchart for determining a signal change rate of the accelerator pedal position sensor 110 to be limited according to an embodiment of the present disclosure.

Referring to FIG. 2, the controller 150 may first determine whether the vehicle 100 is traveling and the SoC of the battery 140 is reduced, for example, from a fully or completely charged state, or is currently being reduced, by discharge due to the operation of the drive motor 121 of the drive unit 120 (S210).

In a case where the vehicle 100 is traveling and the SoC of the battery 140 is reduced by discharge due to the operation of the drive motor 121 (Yes in S210), the controller 150 may receive information on the SoC of the battery 140 from the battery management system 130. The controller 150 may store a signal change amount of the accelerator pedal position sensor 110 output during the time taken for the SoC of the battery 140 to decrease by a preset amount (S220). In the present embodiment, the signal change amount of the accelerator pedal position sensor 110 may be determined by the above-mentioned method, but the present disclosure is not necessarily limited thereto.

In a case where the vehicle 100 is not accelerated by the signal output by the accelerator pedal position sensor 110 or the SoC of the battery 140 is not reduced (No in S210), the controller 150 may omit processes (S220, S230, S240, and S250) for determining the change rate of the output signal of the accelerator pedal position sensor 110 for each power saving mode.

The controller 150 may determine the output signal change rate of the accelerator pedal position sensor 110 for each SoC range of the battery 140 based on the time taken for the SOC of the battery 140 to decrease by the preset amount and the output signal change amount of the accelerator pedal position sensor 110 determined as described above (S230).

The controller 150 may determine a range of the output signal change rate of the accelerator pedal position sensor 110 for the each SoC range (S240), and may determine an output signal change rate of the accelerator pedal position sensor 110 to be limited for each power saving mode of the vehicle 100 in the determined range (S250). There may be various methods for determining the output signal change rate to be limited for each power saving mode by the controller 150, but in the present embodiment, it may be determined using Equation 1, which is provided as an example and is not limitative of the present disclosure.

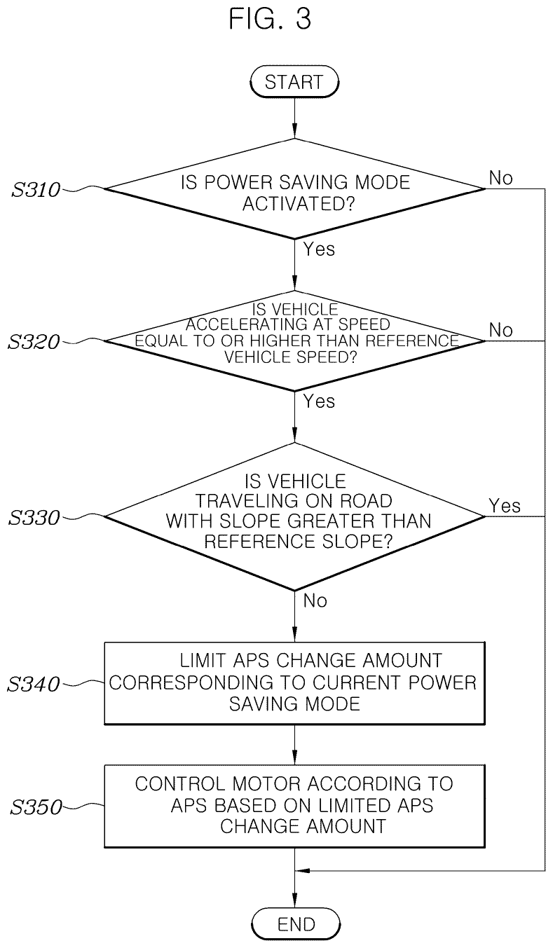

FIG. 3 is a flowchart for controlling the signal change rate of the accelerator pedal position sensor 110 in a case where the vehicle 100 enters the power saving mode according to an embodiment of the present disclosure.

First, the controller 150 may receive an order or input to enter the power saving mode from the driver or may activate the power saving mode according to a preset standard (S310).

In a case where the power saving mode is activated (Yes in S310), the controller 150 may determine whether the vehicle 100 is accelerating at a speed equal to or higher than a preset vehicle speed (S320), and whether the vehicle 100 is traveling on a road with a slope greater than a preset slope (S330).

In a case where the power saving mode is not activated (No in S310), the controller 150 may operate the drive motor 121 without limiting the output signal change rate of the accelerator pedal position sensor 110.

In a case where the vehicle 100 accelerates to the speed equal to or higher than the preset vehicle speed and is traveling on the road with a slope less than or equal to the preset slope (Yes in S320 and No in S330), the controller 150 may limit the output signal change rate of the accelerator pedal position sensor 110 based on the output signal change rate of the accelerator pedal position sensor 110 corresponding to the current power saving mode (S340). Then, the controller 150 may operate the drive motor 121 based on the limited output signal change rate of the accelerator pedal position sensor 110 (S350).

In a case where the vehicle 100 is traveling at a speed that is lower than the preset vehicle speed or on a road with a slope greater than the preset slope (No in S320 and Yes in S330), the controller 150 may operate the drive motor 121 based on the output signal from the accelerator pedal position sensor 110, regardless of the current power saving mode.

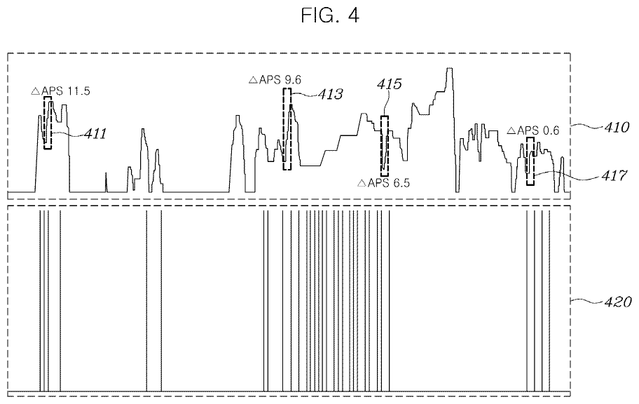

FIG. 4 is a time graph showing a signal value of an accelerator pedal position sensor and a SoC of a battery corresponding thereto according to an embodiment of the present disclosure.

Referring to FIG. 4, the horizontal axis of the graph is a time axis, and two graphs share the same time axis. Graph 410 shows a signal value of the accelerator pedal position sensor 110, which changes continuously over time. Graph 420 is obtained by modeling the moment when the SoC of the battery 140 decreases by a preset amount over time, using the Dirac Delta Function.

Referring to the graph 410, output signal change rates 411, 413, 415, and 417 are shown among the continuously changing signal values of the accelerator pedal position sensor 110. The output signal change rates 411, 413, 415, and 417 are output signal change rates of the accelerator pedal position sensor 110 for each SoC range of the battery 140 determined by the controller 150 in a situation where the SoC of the battery 140 decreases due to discharge by the operation of the drive motor 121. The controller 150 may determine a change rate corresponding to the current power saving mode from the output signal change rates 411, 413, 415, and 417 of the accelerator pedal position sensor 110 derived from the graph 410. For example, in the present embodiment, the controller 150 may determine the change rate corresponding to the current power saving mode using Equation 1 based on the upper limit value of change rate 411 and the lower limit value of change rate 417 among the output signal change rates 411, 413, 415, and 417 derived from the graph 410, and may limit the output signal change rate of the accelerator pedal position sensor 110 within the determined change rate.

Hereinafter, a method for deriving a change amount of the accelerator pedal position sensor 110 for each SoC range of the battery 140 which is a criterion for determining the output signal change rates 411, 413, 415, and 417 of the accelerator pedal position sensor 110 is described in detail with reference to FIGS. 5 and 6.

FIGS. 5 and 6 are graphs illustrating a method for determining a signal change amount of an accelerator pedal position sensor according to an embodiment of the present disclosure.

Referring to FIG. 5, as in FIG. 4, graph 410a continuously shows signal values of the accelerator pedal position sensor 110 over time. Graph 420a is obtained by modeling the moment when the SoC of the battery 140 decreases by a preset amount, using the Dirac Delta Function, corresponding to graph 410a.

In the present embodiment, the output signal change amount of the accelerator pedal position sensor 110 derived from an SoC range 510 of the battery 140 may be an absolute value of a difference 540 between a signal value 520 output by the accelerator pedal position sensor 110 at a starting point of the SoC range 510 of the battery 140 and a signal value 530 output by the accelerator pedal position sensor 110 at an ending point of the SoC range 510 of the battery 140.

Referring to FIG. 6, the same graphs are shown as in FIG. 5. However, the signal change amount of the accelerator pedal position sensor 110 derived from the SoC range 510 of the battery 140 may be different from that in FIG. 5. Specifically, the controller 150 may determine a difference 630 between an upper limit value 610 and a lower limit value 620 of the accelerator pedal position sensor 110 output from the SoC range 510 of the battery 140 as the output signal change amount of the accelerator pedal position sensor 110.

The method for determining the output signal change amount of the accelerator pedal position sensor 110 in FIGS. 5 and 6 is provided as an example and the present disclosure is not necessarily limited thereto.

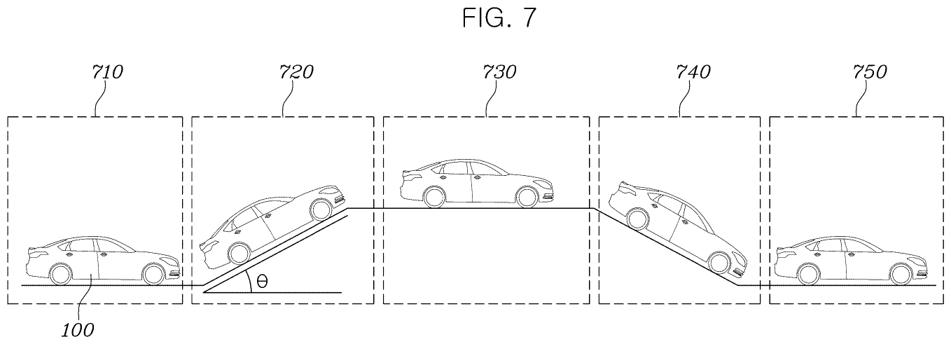

FIG. 7 is a diagram showing the vehicle 100 that is traveling on a road with different slope gradients according to an embodiment of the present disclosure.

Referring to FIG. 7, in a case where the power saving mode is activated as the vehicle 100 is traveling on flat road sections 710, 730, and 750 and the vehicle 100 is accelerating at a speed equal to or higher than a preset reference speed, the controller 150 may operate the drive motor 121 by limiting the output signal change rate of the accelerator pedal position sensor 110 within the output signal change rate corresponding to the current power saving mode.

In a case where the vehicle is traveling on a road section 720 that is inclined by θ, and in a case where θ is greater than a preset slope, the drive motor 121 may be operated based on the output signal from the accelerator pedal position sensor 110, regardless of the output signal change rate corresponding to the current power saving mode, in order to secure high torque for preventing the vehicle 100 from rolling backward by the gradient θ of the road.

On the other hand, in a case where the vehicle 100 is traveling in a downward section 740, it is not necessary to secure high torque. Thus, in a case where the vehicle 100 is accelerating at a speed equal to or higher than a preset reference speed, the controller 150 may operate the drive motor 121 by limiting the output signal change rate of the accelerator pedal position sensor 110 within the output signal change rate corresponding to the current power saving mode.

According to the above-described embodiments, it is possible to efficiently reduce consumption of driving energy of the vehicle 100 by considering the driver's accelerator pedal operation.

As should be apparent from the above description, it is possible to reduce consumption of driving energy by controlling an accelerator pedal position sensor in a vehicle according to an embodiment of the present disclosure.

Specifically, by controlling the amount of change in a signal of the accelerator pedal position sensor to use vehicle's driving energy efficiently, it is possible to sufficiently consider driver's quick acceleration tendency.

The effects that may be obtained through the embodiments of this disclosure are not limited to the above-mentioned effects, and other effects not mentioned should be clearly understood by those of ordinary skill in the art from the description.

Although several embodiments of the present disclosure have been disclosed for illustrative purposes, those of ordinary skill in the art should appreciate that various modifications, additions and substitutions are possible, without departing from the scope and spirit of the disclosure as disclosed in the accompanying claims.

What is claimed is:

1. A vehicle comprising:
a drive motor;
a battery;
an accelerator pedal position sensor; and
a controller configured to:
determine an output signal change amount of the accelerator pedal position sensor for a plurality of SoC (State of Charge) ranges of the battery during a period of time taken for a SoC of the battery to decrease by a preset amount due to discharge for operating the drive motor during vehicle driving;
determine a change rate corresponding to a current power saving mode within a range of an output signal change rate per unit time determined based on the output signal change amount for the plurality of SoC ranges; and
limit an output signal change rate of the accelerator pedal position sensor within the determined change rate to operate the drive motor.

2. The vehicle according to claim 1, wherein the output signal change amount of the accelerator pedal position sensor for the plurality of Soc ranges are absolute values of a difference between signal values output by the accelerator pedal position sensor at a starting point and an ending point of each of the Soc ranges of the battery or are absolute values of a difference between a upper limit value and a lower limit value of the signal values output by the accelerator pedal position sensor in each of the SoC ranges of the battery.

3. The vehicle according to claim 1, wherein the power saving mode includes a plurality of stages, and the controller is further configured to determine different change rates within the range of the output signal change rate per unit time for each of the plurality of stages.

4. The vehicle according to claim 3, wherein the controller is further configured to determine a change rate at a current power saving mode stage among the plurality of stages according to the following equation:
$$Δ APS = Δ AP {S}_{M A X} - ( \frac{Δ AP {S}_{M A X} - Δ AP {S}_{MIN}}{N} ) \times m$$
wherein ΔAPS represents the change rate at the current power saving mode stage, ΔAPS_{MAX} represents an upper limit value of change rate in the range of the output signal change rate per unit time, ΔAPS_{MIN} represents a lower limit value of change rate in the range of the output signal change rate per unit time, N represents the number of power saving mode stages, and m represents a numerical value corresponding to the current power saving mode stage.

5. The vehicle according to claim 3, wherein the controller is further configured to determine the power saving mode stage based on a preset standard, or determine the power saving mode stage based on an input to enter the power saving mode received from a driver.

6. The vehicle according to claim 1, wherein the controller is further configured to operate the drive motor by limiting the output signal change rate of the accelerator pedal position sensor within the determined change rate, in a case where a speed of the vehicle is equal to or higher than a preset reference value and a slope of a road on which the vehicle is traveling is less than or equal to a reference slope.

7. The vehicle according to claim 1, wherein the controller is further configured to operate the drive motor based on an output signal of the accelerator pedal position sensor, regardless of the current power saving mode, in a case where a speed of the vehicle is lower than a preset reference value or a slope of a road on which the vehicle is traveling is greater than a reference slope.

8. A method for controlling an accelerator pedal position sensor, comprising:
determining, by a controller, an output signal change amount of the accelerator pedal position sensor for a plurality of SoC (State of Charge) ranges of a battery during a period of time taken for a SoC of the battery to decrease by a preset amount due to discharge for operating a drive motor during vehicle driving;
determining, by the controller, a change rate corresponding to a current power saving mode within a range of an output signal change rate per unit time determined based on the output signal change amount for the plurality of SoC ranges; and
limiting, by the controller, an output signal change rate of the accelerator pedal position sensor within the determined change rate to operate the drive motor.

9. The method according to claim 8, wherein the output signal change amount of the accelerator pedal position sensor for each of the plurality of SoC ranges are absolute values of a difference between signal values output by the accelerator pedal position sensor at a starting point and an ending point of each of the SoC ranges of the battery or absolute values of a difference between an upper limit value and a lower limit value of the signal values output by the accelerator pedal position sensor in each of the SoC ranges of the battery.

10. The method according to claim 8, wherein the power saving mode includes a plurality of stages, and the determining different change rates comprises determining, by the controller, different change rates within the range of the output signal change rate per unit time for each of the plurality of stages.

11. The method according to claim 10, wherein the determining a change rate comprises determining, by the controller, a change rate at a current power saving mode stage among the plurality of stages according to the following equation:
$$Δ APS = Δ AP {S}_{M A X} - ( \frac{Δ AP {S}_{M A X} - Δ AP {S}_{MIN}}{N} ) \times m$$
wherein ΔAPS represents the change rate at the current power saving mode stage, ΔAPS_{MAX} represents an upper limit value of change rate in the range of the output signal change rate per unit time, ΔAPS_{MIN} represents a lower limit value of change rate in the range of the output signal change rate per unit time, N represents the number of power saving mode stages, and m represents a numerical value corresponding to the current power saving mode stage.

12. The method according to claim 10, wherein the controller configured to determine the power saving mode stage based on a preset standard, or determine the power saving mode stage based on an input to enter the power saving mode received from a driver.

13. The method according to claim 8, wherein the operating the drive motor comprises operating the drive motor by limiting the output signal change rate of the accelerator pedal position sensor within the determined change rate, in a case where a speed of the vehicle is equal to or higher than a preset reference value and a slope of a road on which the vehicle is traveling is less than or equal to a reference slope, by the controller.

14. The method according to claim 8, wherein the operating the drive motor comprises operating the drive motor based on an output signal of the accelerator pedal position sensor, regardless of the current power saving mode, in a case where a speed of the vehicle is lower than a preset reference value or a slope of a road on which the vehicle is traveling is greater than a reference slope, by the controller.

15. A vehicle comprising:
a drive motor;
a battery;
an accelerator pedal position sensor; and
a controller configured to:
determine an output signal change amount of the accelerator pedal position sensor for a plurality of SoC (State of Charge) ranges of the battery during a period of time taken for a SoC of the battery to decrease by a preset amount;
determine a change rate corresponding to a current power saving mode within a range of an output signal change rate per unit time determined based on the output signal change amount for the plurality of SoC ranges; and
limit an output signal change rate of the accelerator pedal position sensor within the determined change rate.

16. The vehicle according to claim 15, wherein the output signal change amounts of the accelerator pedal position sensor for the plurality of SoC ranges are absolute values of a difference between signal values output by the accelerator pedal position sensor at a starting point and an ending point of each of the Soc ranges of the battery or are absolute values of a difference between an upper limit value and a lower limit value of the signal values output by the accelerator pedal position sensor in each of the SoC ranges of the battery.

17. The vehicle according to claim 15, wherein the power saving mode includes a plurality of stages, and the controller is further configured to determine different change rates within the range of the output signal change rate per unit time for each of the plurality of stages.

18. The vehicle according to claim 17, wherein the controller is further configured to determine the power saving mode stage based on a preset standard.

19. The vehicle according to claim 17, wherein the controller is configured to determine the power saving mode stage based on an input to enter the power saving mode received from a driver.

20. The vehicle according to claim 15, wherein the controller is further configured to operate the drive motor based on an output signal of the accelerator pedal position sensor, regardless of the current power saving mode, in a case where a speed of the vehicle is lower than a preset reference value or a slope of a road on which the vehicle is traveling is greater than a reference slope.
